(19) United States
(12) Patent Application Publication
(10) Pub. No.: US 2009/0001136 A1
(43) Pub. Date: Jan. 1, 2009

(54) Apparatus and Method for Rotational Friction Welding

(75) Inventors: Karsten Dzialas, Muenchen (DE); Steffen Weber, Dachau (DE)

Correspondence Address: CROWELL & MORING LLP;INTELLECTUAL PROPERTY GROUP, P.O. BOX 14300, WASHINGTON, DC, 20044-4300, US

(73) Assignee: MTU AERO ENGINES GmbH, Munich (DE)

(21) Appl. No.: 11/575,964

(22) PCT Filed: Sep. 17, 2005
(86) PCT No.: PCT/DE2005/001639

§ 371 Date: Sep. 9, 2008

(30) Foreign Application Priority Data
Sep. 23, 2004 (DE) 10 2004 046 087.6

(51) Int. Cl. B23K 20/12

(52) U.S. Cl. 228/114.5; 228/2.3

(57) ABSTRACT

A rotational friction welding apparatus and method for joining two components is disclosed. The apparatus includes a first spindle which turns and a second spindle which does not turn. A first component of the components that are to be connected together is mounted on the first, turning spindle, and a second component of the components that are to be connected together is mounted on the second, non-turning spindle, respectively, by way of a clamping device. Associated at least with the clamping device that is used to mount the first component on the first, turning spindle there is a planar toothing which for centering purposes and torque-transfer engages into a corresponding planar toothing associated with the first component.

This application claims the priority of International Application No. PCT/DE2005/001639, filed Sep. 17, 2005, and German Patent Document No. 10 2004 046 087.6, filed Sep. 23, 2004, the disclosures of which are expressly incorporated by reference herein.

### BACKGROUND AND SUMMARY OF THE INVENTION

The invention relates to a rotational friction welding system and method.

In the case of the manufacture of gas turbines, friction welding is a common joining method. Friction welding is one of the so-called pressure-welding methods, with a distinction being made in the case of friction welding inter alia between so-called linear friction welding and rotational friction welding. The present invention relates to so-called rotational friction welding, in which rotationally symmetrical components are joined to each other or connected together by means of friction. In the case of rotational friction welding a first component rotates, while the other component stands still and is pressed with a certain force against the rotating component. During this, joint faces of the components that are to be connected together are adapted to each other by means of hot forging.

Rotational friction welding is carried out on so-called rotational friction welding systems, where in accordance with the prior art the rotating component is mounted on a spindle which turns and the stationary component is mounted on a spindle which does not turn. In accordance with the prior art, the rotating component is mounted on the first, turning spindle and the stationary component is mounted on the second, non-turning spindle respectively by way of a clamping device. In accordance with the prior art, as a rule devices that are formed as collet chucks are used. Since in the case of rotational friction welding increasingly greater welding moments need to be transferred and supported, mounting the components that are to be connected together on the spindles by way of such collet chucks causes problems, since in consequence of high welding moments high clamping forces are required that can lead to component deformations. Furthermore, the components and the collet chucks are subject to a risk of so-called fretting and cold-welding, which is why mounting the components on the spindles by way of the collet chucks that are known from the prior art is disadvantageous.

In order to support the torque it is already known from the prior art to work grooves with a depth of approximately 10 mm into the rotating component that is mounted on the turning spindle, with groove blocks that are associated with the clamping device engaging into the grooves. In accordance with the prior art two to four grooves are positioned over the periphery of the component, with a respective groove block engaging into each of these grooves. The use of such grooves in the component has the disadvantage that in consequence of the relatively large depth of the grooves and also in consequence of the safety allowance, to be provided on account of possible cold-deformation, after the rotational friction welding considerable removal of material is still required in order to adapt the components that are connected together to the desired final contour. Furthermore, on account of the considerable manufacturing tolerances in the case of the production of such grooves, it is not possible to center the component on the spindle. Such grooves are also used in accordance with the prior art in order to support the component that is mounted on the non-turning spindle.

Basing considerations on this, the underlying problem of the present invention is to provide a novel rotational friction welding system.

In accordance with the invention associated at least with the clamping device that is used to mount the first component on the first, turning spindle there is a planar toothing which for centering purposes and torque-transfer engages into a corresponding planar toothing associated with the first component.

Within the meaning of the present invention it is provided that a planar toothing be used at least to mount the rotating component on the turning spindle, with there being associated with the clamping device of the turning spindle, on the one hand, and with the rotating component that is to be mounted on this spindle, on the other hand, respective planar toothings that engage into each other in the event of mounting. A mounting by way of such planar toothings renders possible play-free transfer of very large torques and is, furthermore, self-centering. Furthermore, only a small safety allowance needs to be provided for on the components to be connected together. A planar toothing can be constructed as an end curved toothing (curvic coupling) or a Hirth-type serration.

In accordance with an advantageous further development of the invention, there is a planar toothing also associated with the clamping device that is used to mount the second component on the second, non-turning spindle; for centering purposes this toothing engages into a corresponding planar toothing associated with the second component.

Preferred further developments of the invention emerge from the following description. An exemplary embodiment of the invention is explained in greater detail, without limitation thereto, with the aid of the drawings.

### BRIEF DESCRIPTION OF THE DRAWINGS

FIG. 1 shows a diagrammatic representation of a rotational friction welding system in accordance with the prior art;

FIG. 2 shows a rotational friction weld seam between two components that are connected together;

FIG. 3 shows a diagrammatic detail of a rotational friction welding system in accordance with the invention; and

FIG. 4 shows a further diagrammatic detail of the rotational friction welding system in accordance with the invention.

### DETAILED DESCRIPTION OF THE DRAWINGS

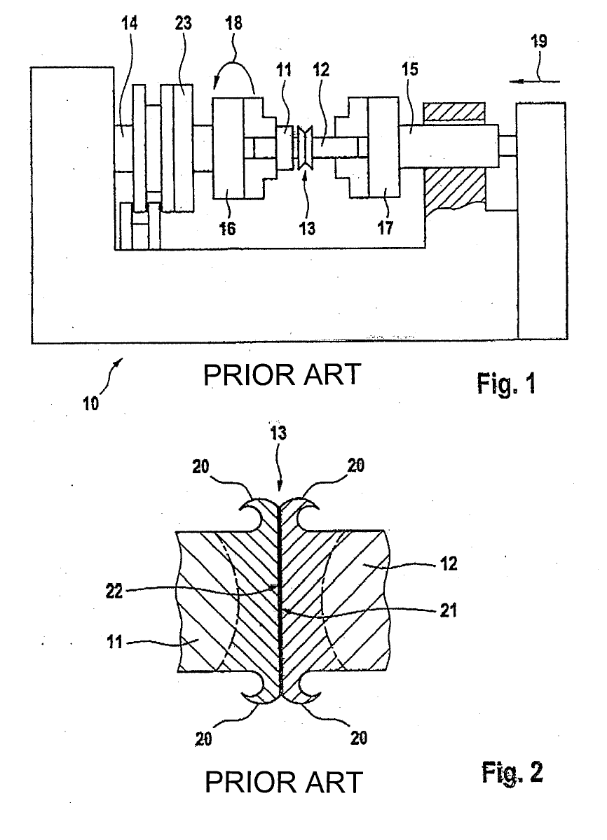

FIG. 1 shows a rotational friction welding system 10 for joining two components 11 and 12 in accordance with the prior art, with the connection seam 13, which is shown on an enlarged scale in FIG. 2, being formed between the components 11 and 12 in the case of rotational friction welding. The rotational friction welding system 10 in accordance with the prior art that is shown in FIG. 1 is provided with a first, turning spindle 14 and a second, non-turning spindle 15. Of the components 11 and 12 that are to be connected together the component 11 is arranged or mounted on the first, turning spindle 14, and the component 12 is arranged or mounted on the second, non-turning spindle. For this purpose, respective clamping devices 16 and 17 are associated with the spindles 14 and 15. The components 11 and 12 that are to be connected together can be secured to the respective spindle 14 or 15 with the aid of the clamping devices 16 and 17.

In order now to connect the two components 11 and 12 together with the aid of rotational friction welding, the component 11 that is mounted on the first, turning spindle 14 is moved so that it turns in the direction of arrow 18, with the component 12 that is mounted on the second, non-turning spindle 15 being pressed against the component 11 with a force in the direction of arrow 19. The relative rotation between the components 11 and 12 and also this force produce friction and thus a rise in temperature of the two components 11 and 12 at contact surfaces 21, 22 of the same. There then follows hot-forging of the material of the components 11 and 12 at the contact surfaces. The connection bead 20 that is diagrammatically shown in FIG. 2 is formed in this case.

Associated with the rotational friction welding system 10 according to the prior art there is in accordance with FIG. 1, namely in the region of the first, turning spindle 14, a centrifugal-mass body 23. This centrifugal-mass body 23 of the rotational friction welding system 10 is adapted to the components 11 and 12 that are to be connected together.

In the case of rotational friction welding increasingly higher welding moments are to be transferred and also supported, which is why the demands on the clamping devices 16 and 17, used to mount the components 11 and 12 that are to be connected together on the spindles 14 and 15, are increasingly rising. Thus not only do the clamping devices 16 and 17 need to transfer and also support the high welding moments, but rather component deformations resulting from clamping forces acting by way of the clamping devices 16 and 17 on the components 11 and 12 that are to be connected together are furthermore to be minimized, so that it is possible to join the components exactly by way of rotational friction welding. The guarantee of exactly centering the components 11 and 12 on the respective spindles 14 and 15 also pertains to this.

Within the meaning of the present invention it is provided that a so-called planar toothing be associated at least with the clamping device 16 that is used to mount the first, rotating component 11 on the turning spindle 14, in the front region. The planar toothing, associated with the clamping device 16 of the turning spindle 14, engages for the purpose of mounting the first component 11 into a corresponding planar toothing that is associated with the first component 11. The mounting of the rotating component 11 on the turning spindle 14 by way of such a planar toothing renders possible play-free transfer of high torques or welding moments and is, furthermore, self-centering. The compressive force that is applied when joining sustains the transferable moment and in the case of a planar toothing that is formed as an end curved toothing (curvic coupling) also the self-centering.

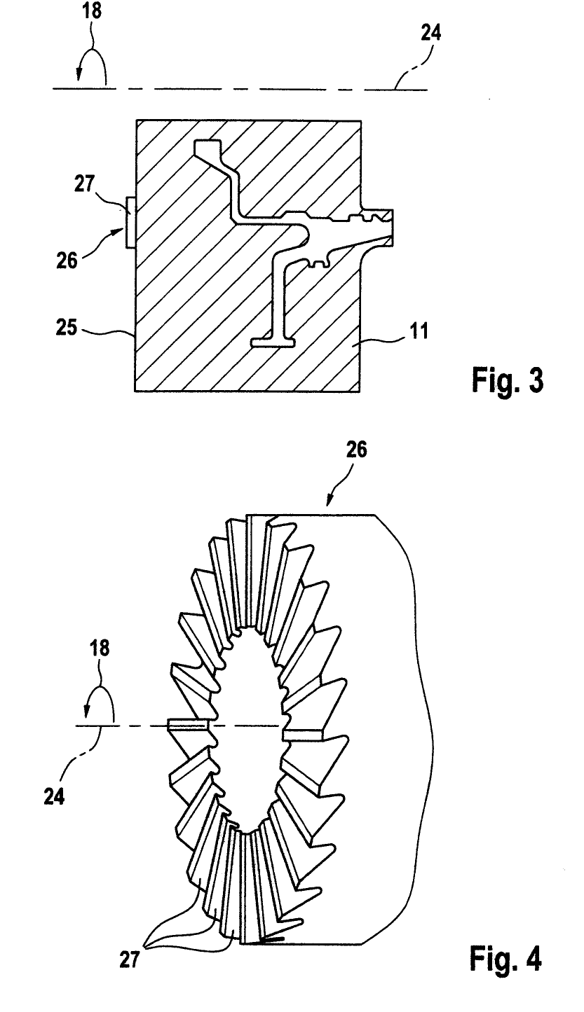

FIG. 3 shows a cutaway portion of a rotationally symmetrical component 11 which, as a component that rotates in the case of rotational friction welding, is to be mounted on the turning spindle 14, which is not shown in FIG. 3. The axis of symmetry and therefore the axis of rotation in the case of rotational friction welding of the component 11 is marked by the reference numeral 24 in FIG. 3. The component 11 that is shown in FIG. 3 can, for example, be a seal-carrier. As can be inferred from FIG. 3, a planar toothing is associated with an end face 25 of the component 11. This planar toothing 26 that is associated with the component 11 engages into a planar toothing, which is not shown, of the clamping device 16. The planar toothing is formed by a plurality of teeth 27. FIG. 4 diagrammatically shows in a perspective view a possible configuration of a planar toothing 26 with the teeth 27 that form the planar toothing.

When such a planar toothing 26 is used to center the turning component 11 on the turning spindle 14 of the rotational friction welding system 10, a tooth depth of 2 to 6 mm, in particular of 3 to 4 mm, is sufficient in order to transfer even high torques or welding moments. In addition, on account of the relatively high number of teeth 27 of such a planar toothing 26, the safety allowance at the component 11 can be kept small. All in all, as a result it is guaranteed that after two components that are to be connected together have been connected, only little finishing is required in order to provide the desired final-contour state of the components that are connected together.

Preferably not only the mounting of the rotating component 11 on the turning spindle 14 is effected by way of planar toothings, but rather, associated with the clamping device 17 used to mount the non-rotating component 12 on the non-turning spindle 15, there is in particular also a corresponding planar toothing which for centering purposes engages into a corresponding planar toothing that is associated with the component 12. Both components are therefore preferably centered on the spindles and the corresponding clamping devices respectively by way of planar toothings.

Axial fixation of the components 11 and 12 that are aligned or centered on the spindles 14 and 15 with the aid of the planar toothings in the peripheral direction and also in the radial direction is effected by way of the clamping devices 16 and 17. Since the planar toothings already take over the torque-support and thus the torque-transfer, only small clamping forces need to be provided for by the clamping devices 16 and 17 for the purposes of axial fixation so that the risk of component deformations in consequence of such clamping forces is clearly reduced. For pre-centering purposes, lightly clamping centering rings can be associated with the clamping devices 16 and 17.

Play-free mounting of the components that are to be connected together on the corresponding spindles is possible with the aid of the present invention. As a result, oscillations and inaccuracies during the welding process are minimized. A further advantage of the present invention in comparison with the prior art lies in the fact that when mounting with the aid of the planar toothings the high clamping forces transmitted by collet chucks and necessary in accordance with the prior art can be dispensed with so that component deformations during welding and also the introduction of internal stresses into the weld can be prevented. Since, furthermore, merely a smaller safety allowance is required at the components that are to be connected together, the outlay when machining the components that are connected together in order to provide the final-contour state of the same is also reduced. The compressive force that is to be applied during the welding assists the centering of the components and the transferable moment.

The savings made in the component allowance or the safety allowance at the components that are to be connected together lies in a range of up to 15 mm. The planar toothings can be removed with little outlay from components that are connected together.

1-5. (canceled)

6. A rotational friction welding system for joining two components, having a first spindle which turns and a second spindle which does not turn, wherein a first component of the components that are to be connected together is mounted on the first, turning spindle, and a second component of the components that are to be connected together is mounted on the second, non-turning spindle, respectively by way of a clamping device, wherein associated at least with the clamping device that is used to mount the first component on the first, turning spindle there is a planar toothing which for centering purposes and torque transfer engages into a corresponding planar toothing associated with the first component.

7. The rotational friction welding system according to claim 6, wherein also associated with the clamping device that is used to mount the second component on the second, non-turning spindle there is a planar toothing which for centering purposes engages into a corresponding planar toothing associated with the second component.

8. The rotational friction welding system according to claim 6, wherein a tooth depth of the planar toothing lies between 2 mm and 6 mm.

9. The rotational friction welding system according to claim 8, wherein the tooth depth of the planar toothing lies between 3 mm and 4 mm.

10. The rotational friction welding system according to claim 6, wherein the planar toothing is associated with an end face of the clamping device and also an end face of the first component that is mounted on the clamping device.

11. The rotational friction welding system according to claim 6, wherein the planar toothing is formed as self-centering curvic toothings.

12. An apparatus for rotational friction welding, comprising:
a first rotatable spindle with a first clamping device; and
a second non-rotatable spindle with a second clamping device;
wherein the first clamping device includes a planar toothing on an end face of the first clamping device.

13. The apparatus according to claim 12, wherein the planar toothing includes a plurality of teeth.

14. The apparatus according to claim 12, wherein the second clamping device includes a second planar toothing on an end face of the second clamping device.

15. The apparatus according to claim 14, wherein the second planar toothing includes a second plurality of teeth.

16. The apparatus according to claim 13, wherein the end face of the first clamping device is disposed at an end of the first clamping device that is opposed to an end of the first clamping device that faces the first rotatable spindle.

17. The apparatus according to claim 15, wherein the end face of the second clamping device is disposed at an end of the second clamping device that is opposed to an end of the second clamping device that faces the second non-rotatable spindle.

18. The apparatus according to claim 13, wherein the end face of the first clamping device is disposed at a longitudinal end of the first clamping device.

19. The apparatus according to claim 15, wherein the end face of the second clamping device is disposed at a longitudinal end of the second clamping device.

20. The apparatus according to claim 13, wherein the plurality of teeth extend from the end face of the first clamping device.

21. The apparatus according to claim 15, wherein the second plurality of teeth extend from the end face of the second clamping device.

22. A method for rotational friction welding of a first component to a second component, comprising the steps of:
engaging a planar toothing included on an end of the first component with a planar toothing included on an end of a first clamping device coupled to a first rotatable spindle;
engaging a planar toothing included on an end of the second component with a planar toothing included on an end of a second clamping device coupled to a second non-rotatable spindle;
engaging the first component with the second component;
applying pressure to the engaged first and second components; and
rotating the first component by the first rotatable spindle.

23. The method according to claim 22, further comprising the steps of centering the first and second components on the first and second spindles, respectively, by the steps of engaging.

24. The method according to claim 22, further comprising the step of removing the planar toothings from the first and second components after the first component is welded to the second component.

25. The method according to claim 22, wherein the end of the first component is disposed at a longitudinal end of the first component and wherein the end of the second component is disposed at a longitudinal end of the second component.
